(19) United States
(12) Patent Application Publication
(10) Pub. No.: US 2008/0033811 A1
(43) Pub. Date: Feb. 7, 2008

(54) Multitrack, behavior-based marketing system

(76) Inventors: Bryan R. Brown, Moorhead, MN (US); Robert E. Johnson, Fargo, ND (US); James D. Hendrickson, Fargo, ND (US); Andrea F. Anderson, Moorhead, MN (US)

Correspondence Address: FISH & RICHARDSON P.C., PO BOX 1022, MINNEAPOLIS, MN, 55440-1022, US

(21) Appl. No.: 11/499,004

(22) Filed: Aug. 4, 2006

(51) Int. Cl. G06Q 30/00

(52) U.S. Cl. 705/14

(57) ABSTRACT

A computer-implemented method for managing participants of a marketing campaign is disclosed. The method includes generating a marketing campaign with multiple tracks. Each track comprises one or more steps that indicate an activity executed on campaign participants. The method also includes generating segmentation conditions based on natural language statements. Each segmentation condition includes a rule and a time condition. Additionally, the method includes associating a campaign participant from a first track to a second track if behavior information satisfies a segmentation condition. The behavior information includes a response by the campaign participant to an activity indicated by a step in the first track.

### TECHNICAL FIELD

This document relates to a multitrack rules-based marketing system and method.

### BACKGROUND

Some current marketing campaign systems may send communications, such as emails to contacts. Sometimes the systems may send the communications at times when the contacts may not receive them promptly, such as on the weekends. The system may send out a generic communication to all of the contacts regardless of the contacts' responses to previous communications. In some systems, the content of the communication may not be adequately customized to the contacts' needs or preferences. If the system sends out communications that are more customized, the system may require a user to manually specify that a particular campaign participant or set of participants receive the customized communications.

Also, in some systems, a list of contacts participating in the marketing campaign is static. The system adds the contacts at the start of the campaign, and a user may have to directly add or initiate the addition of any new contacts. Similarly, the user may have to directly delete or initiate the deletion of contacts from the campaign.

### SUMMARY

This document describes systems and techniques for generating and managing campaign participants within a marketing campaign. In general, the systems and techniques may create a marketing campaign with multiple marketing tracks, which consist of a series of marketing related activities, such as communications with a campaign participant or routing the campaign participant's information to a lead recipient that pursues the lead. The systems and techniques can move a campaign participant from one marketing track to a different marketing track based on whether behavior of the campaign participant satisfies a segmentation condition, which may be specified by a natural language rule.

For example, the segmentation condition may include the statement “Has the campaign participant opened the last email sent?” If the campaign participant has opened the last email, he or she can be associated with a second marketing track for participants that have responded positively to previous communications. If the campaign participant did not open the last email, he or she can remain in the same marketing track, which may include marketing activities directed to non-responsive participants.

The systems and techniques described here may provide one or more of the following advantages. First, the systems may provide a simplified design mechanism for a multitrack, precision marketing campaign. The systems may use natural language statements to generate conditions used to evaluate what activities (e.g., communications, re-routing a campaign participant, etc.) the systems should initiate or transmit to a campaign participant. Second, systems may automatically associate campaign participants with different marketing tracks based on the participants' responses to previous communications. Third, systems may execute a campaign or individual steps of a campaign based on time conditions specified by a user. Fourth, systems may provide flexibility to build simple or complex marketing campaigns with integrated campaign-tailored resources, such as emails, microsites, surveys, direct mail, call scripts, content for personal digital assistants (PDAs), cellular telephone messages (e.g., short messaging service (SMS) and text messaging, and detailed execution settings. Fifth, systems may utilize targeted, dynamically generated messaging and content based on a users actions, activities, and past marketing response behavior.

The details of one or more embodiments are set forth in the accompanying drawings and the description below. Other features and advantages of the described embodiments will be apparent from the description and drawings, and from the claims.

### DESCRIPTION OF DRAWINGS

FIG. 1 is a schematic diagram of a system for executing a behavior-based marketing campaign according to one implementation.

FIG. 2 is a block diagram of an example of a marketing application used in the system of FIG. 1.

FIG. 3 is a flowchart of an illustrative method for generating the behavior-based marketing campaign executed by the system of FIG. 1.

FIGS. 4A-4G are examples of graphical user interfaces (GUIs) generated by the system during the generation of the behavior-based marketing campaign.

FIGS. 5A and 5B are examples of GUIs generated by the system during generation of track routes and lead routes.

FIG. 6 is an example of a behavior-based marketing campaign with multiple tracks.

FIG. 7 is a flowchart of an illustrative method for routing campaign participants based on their behavioral information.

FIGS. 8A-8C are examples of GUIs generated by the system during analysis of the behavior-based marketing campaign.

FIG. 9 is a schematic diagram of a general computing system.

Like reference symbols in the various drawings indicate like elements.

### DETAILED DESCRIPTION

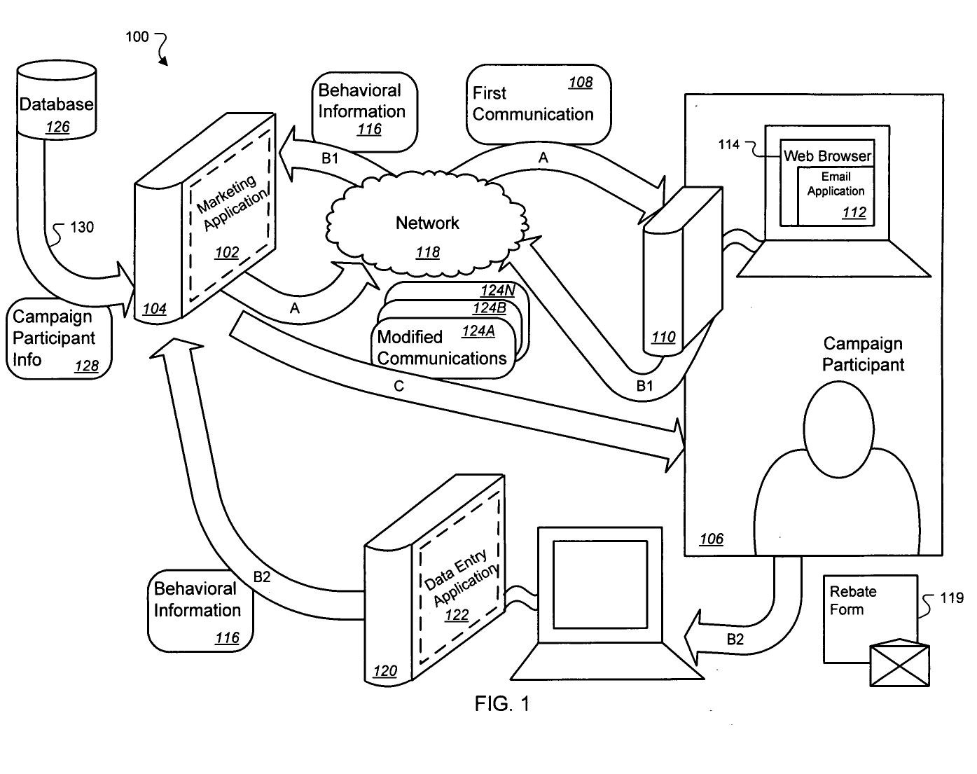

An illustrative system 100 shown in FIG. 1 can generate a marketing campaign that includes several marketing tracks. Each of the tracks can contain steps, which specify communications to be sent to a campaign participant of the marketing campaign. After sending a communication associated with a first marketing track, the system 100 can associate a campaign participant with a different marketing track based on the campaign participant's response to previous communications. For example, one of the steps in a first marketing track may include sending a campaign participant an email that includes a hyperlink to a survey. If the campaign participant selects the hyperlink before a certain date, the system 100 can route the campaign participant to a separate marketing track, which can specify different communications for transmission to the campaign participant. If the campaign participant does not respond by clicking on the hyperlink within a certain time, the system 100 may execute the next step in the same marketing track, which can specify a second communication, such as a direct mailing.

The system 100 can facilitate automated movement of campaign participants between multiple marketing tracks in a marketing campaign based on the campaign participants' behavior, demographic attributes, firmagraphic attributes (e.g., business demographic information, such as total number of employees, residential population, sales volume, legal status, region, etc.), or response to previous communications. The movement of campaign participants between separate tracks may depend upon a time condition. For example, the participants' behavior may have to satisfy a routing condition within a time specified by the time condition before the system routes, or associates, the participants with a different track. Additionally, the system can set a time condition so that the system 100 does not perform the communications indicated by the steps until the condition is met. For example, the step may indicate that the system will transmit an email to the campaign participants, but a time condition associated with the step can indicate that the system will only transmit the email on weekdays between 9 a.m. and 5 p.m. The system 100 and its associated aspects and context are described in more detail below.

FIG. 1 is a schematic diagram of the system 100 for executing a behavior-based marketing campaign according to one implementation. The system 100 can include a marketing application 102 on a first computing device 104 and campaign participants, such as a campaign participant 106. Communication with the campaign participant 106 can be accomplished in several ways. For example, the marketing application 102 can transmit a first communication 108, such as an email including a hyperlink to an online survey, to a second computing device 110, such as a computer owned by the campaign participant 106. The transmission of the first communication 108 is indicated by arrow A. The participant 106 can view the email with an email application 112 and select the hyperlink to participate in the online survey. The hyperlink can open a Web browser 114, which navigates to the survey.

If the campaign participant 106 responds to the first communication 108, the second computing device 110 can transmit behavioral information 116 to the marketing application 102. The transmission of the behavioral information 116 is indicated by arrow B1. For example, when the participant 106 accesses the online survey with the second computing device, a web server (e.g., included in a network 118) hosting the online survey can transmit a message to the marketing application 102. The message can indicate that the campaign participant selected the hyperlink in the email to access the online survey. Additionally, the message can indicate what time the campaign participant accessed the online survey. The behavioral information 116 can include the message. The transmissions between the first and second computing devices 102, 110, respectively, may take place over the network 118, such as the Internet.

In another example, the first communication 108 may include a digital document, such as a rebate form. The campaign participant 106 can print the digital rebate form and complete it. The campaign participant can mail the printed rebate form 119 to an address specified on the form. For example, the address may specify a data center where a person enters the rebate information into a third computing device 120. A data entry application 122 can transmit the rebate information (or an indication that the rebate information was completed) to the marketing application 102 on the first computing device 104. The transmission of the rebate form 119 from the data center to the marketing application to the data center is indicated by arrow B2, and behavioral information 116 can include the transmitted information (e.g., the digitally entered information associated with the rebate form).

Upon receiving the behavioral information 116, the marketing application 102 can determine whether the behavioral information satisfies a routing condition of a routing rule. The routing rule may associate the campaign participant with a different marketing track if the routing condition is satisfied. For example, a marketing campaign generated by the marketing application 102 can contain several marketing tracks. Each marketing track can include one or more steps that specify a communication for transmission to campaign participants. A first marketing track can include communications that are to be sent to the campaign participants who have not responded previous communications. A second marketing track can include communications that are sent to the campaign participants that have responded to previous communications (or that have responded in a predetermined manner). If the behavioral information 116 indicates that the campaign participant has responded to a communication, the marketing application 102 may move the campaign participant (e.g., associate the campaign participant's information) from the first track to the second track. The movement may be made to the beginning of a track or to a point internal to the track.

Additionally, the marketing application 102 can specify, using a time condition, that the behavioral information 116 should occur before a predefined time. For example, even if the behavioral information 116 indicates that the campaign participant 106 has responded to a previous communication, the marketing application 102 may not move the campaign participant to the second track unless the campaign participant's response was within a time specified by the time condition.

After the marketing application 102 moves the campaign participant 106 to the second track, modified communications 124A-N can be transmitted to the campaign participant 106. If the marketing application 102 moves the campaign participant 106 to the second track, the marketing application 102 can send the campaign participant 106 communications that are different than the campaign recipient 106 would have received if the recipient remained in the first track. For example, if the marketing application 102 moves the campaign participant to the second track, the participant can receive communications, such messages acknowledging a previous response or messages that attach coupons or discounts. The modified communications 124A-N can include several types of communications, such as email messages, direct mailings, and telephone calls. The transmission of the modified communications 124A-N is indicated by arrow C.

The marketing application 102 can select campaign participants from a database 126. The database 126 may include contact information for people and businesses. Other computing devices (not shown) can transmit the contact information to the database or the contact information can be input directly through data entry. A user of the marketing application 102 can specify campaign entry criteria, which is used to filter the importation of contact information from the database so that the application only retrieves contacts that meet the campaign entry criteria. The importation of campaign participant information 128 (e.g., contact information that satisfied the campaign entry criteria) is indicated by arrow 130.

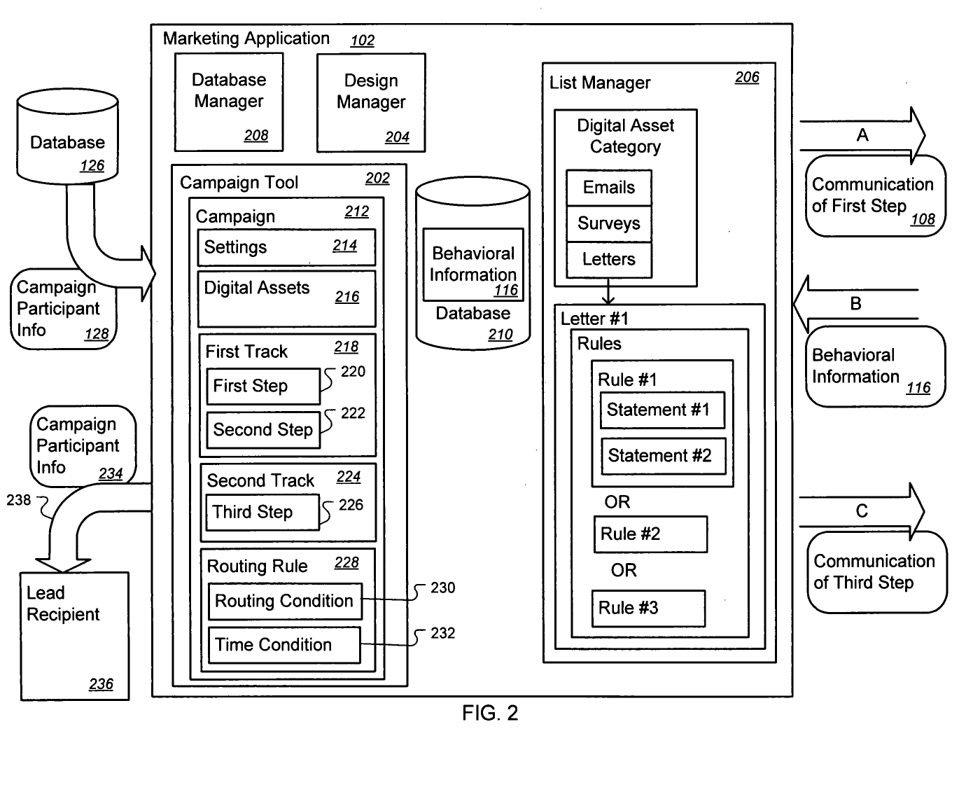

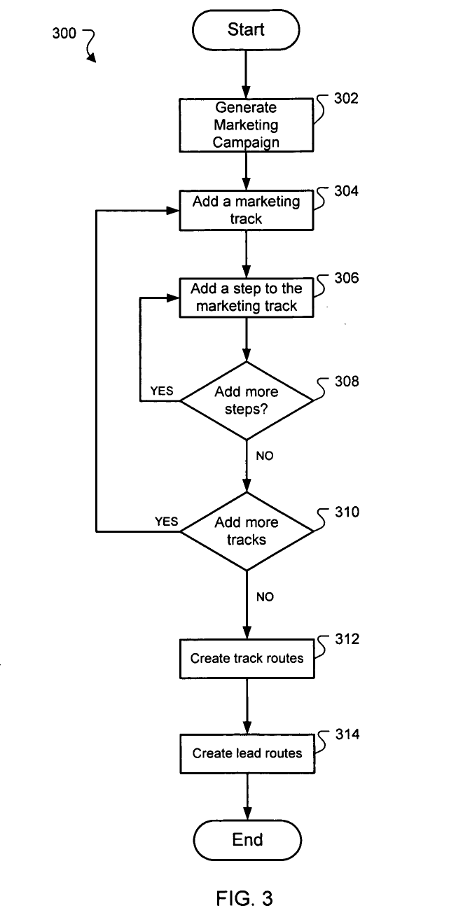

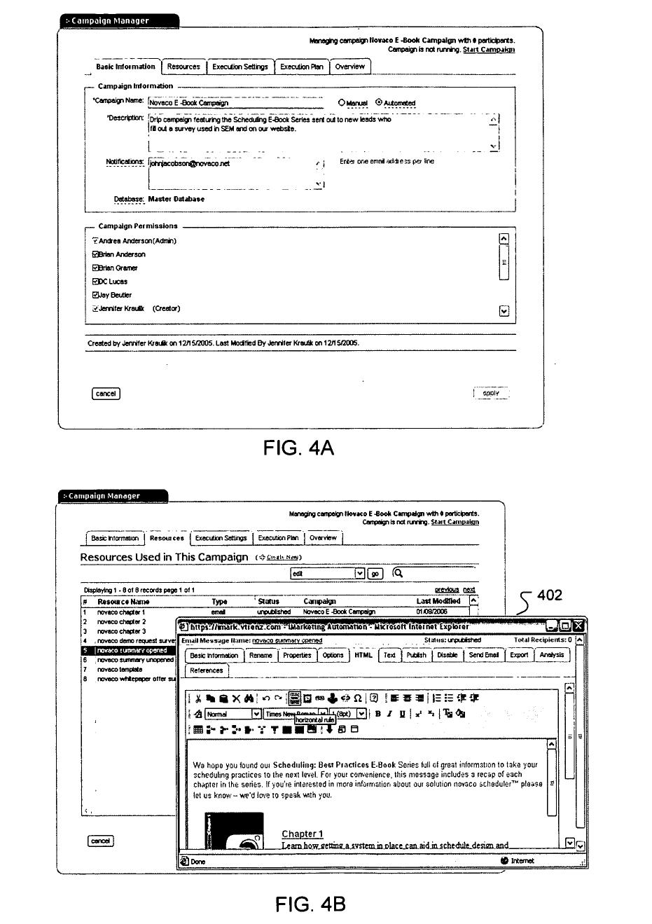

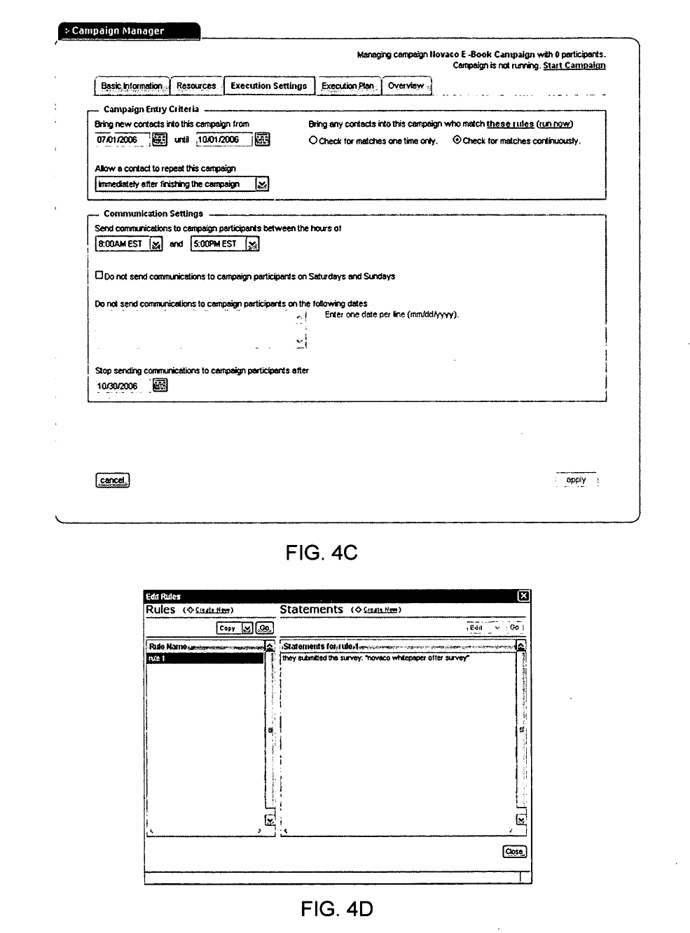

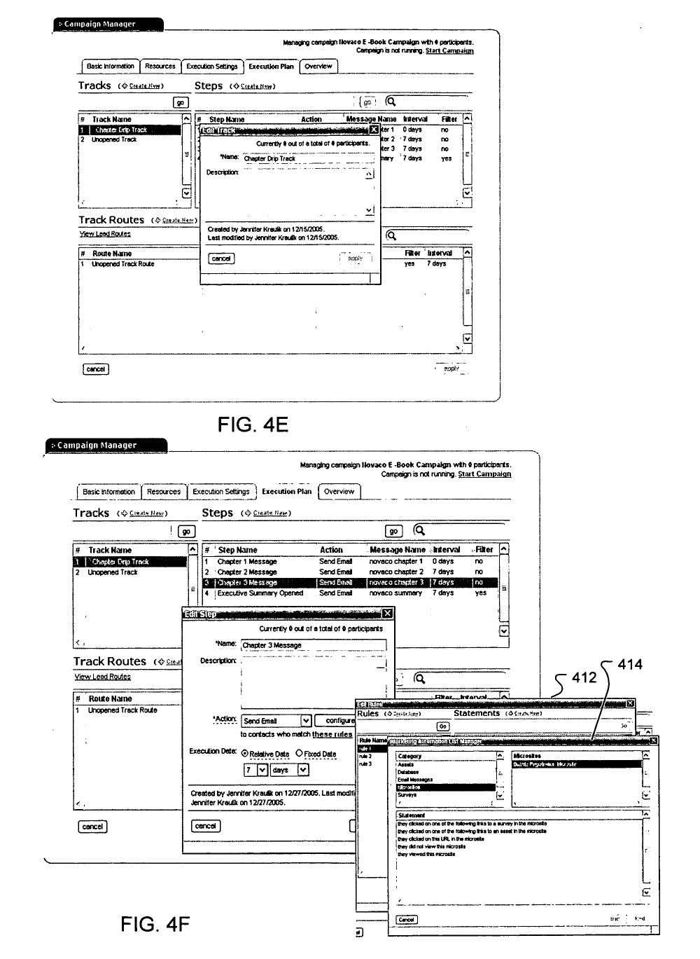

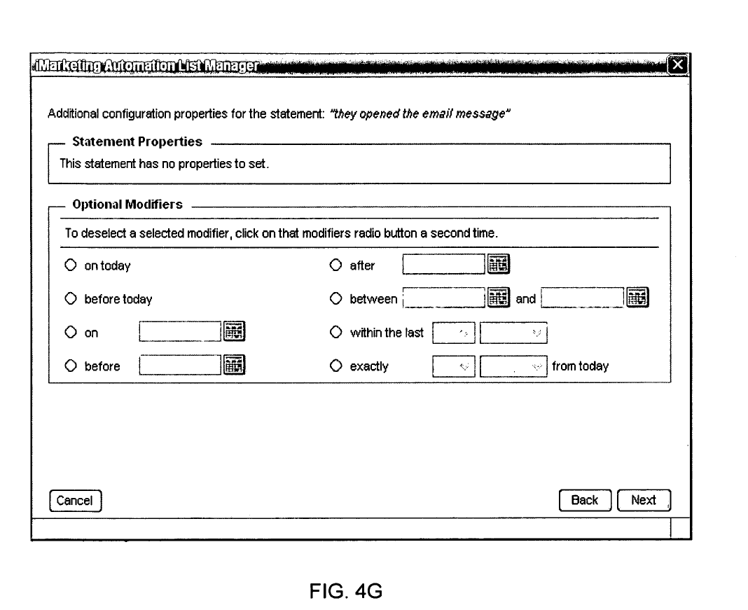

FIG. 2 is a block diagram of an example of the marketing application 102 used in the system of FIG. 1. The marketing application 102 can include a campaign tool 202 used to generate a marketing campaign, a design manager 204 used to design digital assets used in marketing campaigns, a list manager 206 to build rules associated with the campaign participants, tracks, steps, and activities, and a database manager 208 to interface with a database 210 that stores information about the communications sent to campaign participants and the participants' behavioral information 116, or responses. Interactions and functions of the blocks in FIG. 2 will be described in more detail in association with FIG. 3 and FIGS. 4A-I.

### Generation of a Marketing Campaign

FIG. 3 is a flowchart of an illustrative method 300 for generating the behavior-based marketing campaign executed by the system of FIG. 1. The method can start when the marketing application 102 generates a marketing campaign 302 using the campaign tool 202. For example, the tool 202 can generate a campaign 212 as indicated by FIG. 2.

FIGS. 4A-4G are examples of graphical user interfaces (GUIs) generated by the system 100 during the generation of the behavior-based marketing campaign. FIG. 4A shows a GUI where a user may enter information, such as a campaign name, a campaign description, email addresses to notify with campaign related messages, and a database from which to import campaign participants. The user may enter this information under a “Basic Information” tab of the GUI. This information may be stored as part of settings 214 shown in FIG. 2.

FIG. 4B is a GUI where a user may associate digital assets 216, or resources, with the campaign. For example, the user may create and edit assets 216 under the “Resources” tab of the GUI. This GUI can provide an interface to the design manager 204, which can create, edit, and remove the assets 216. The assets 216 can include templates, emails, surveys, microsites, web pages, direct mailings, or any combination thereof. The example shown in FIG. 4B illustrates a user viewing an email 402 that the marketing application 102 can transmit to a campaign participant if the participant has opened a previous communication, such as previous chapters of an electronic book emailed to the campaign recipient. The user can edit the content of the email, as shown in a separate window displaying the email 402. For example, the user can edit the HTML formatting of the document when the user selects the “HTML” tab.

FIG. 4C shows a GUI where the user may enter execution settings for the campaign. For example, under the “Execution Settings” tab, the user can enter settings, such as when new contacts are brought into the campaign (e.g., when the contacts may become campaign participants). The user can also enter what times of the day and dates that the campaign should run (e.g., when the campaign participants should receive communications, what days to avoid sending communications, and what date to stop sending communications).

Additionally, by selecting the hyperlink labeled “these rules,” the user may modify campaign entry criteria, which determines which contacts are imported. This is shown in greater detail in FIG. 4D. FIG. 4D shows a GUI that includes a “rule 1” for determining what contacts should be imported and become campaign participants. Each rule may include one or more statements. For example, the “rule 1” includes one statement. This statement can be recited as a natural language statement that is easily created and understood by users. For example the statement shown in FIG. 4D is “they submitted the survey: “novaco whitepaper offer survey.” This statement is satisfied if behavioral information associated with a contact indicates that the contact submitted a document referred to as the “novaco whitepaper offer survey.” Upon satisfaction of the statement's condition, the rule is satisfied, and the marketing application can add the corresponding contacts to the campaign.

Although not shown in FIG. 4D, the campaign entry criteria may have more than one rule, and each rule can have more than one statement. In some embodiments, all the conditions specified by the statements must be satisfied before the rule is satisfied (e.g., the conditions are logically AND-ed). Additionally, the statements may be logically OR-ed to determine if the rule is satisfied. The marketing application 102 also can import contacts if their associated information matches one or more rules. In other embodiments, the application 102 may require information associated with a contact to satisfy all the rules before the contact is imported as a campaign participant.

Referring again to FIG. 3, after the generation of the marketing campaign 302, marketing tracks can be added to the marketing campaign. For example, the user can add the first track 218 to the marketing campaign 212. The user may enter information associated with the track in a GUI, such as the GUI shown in FIG. 4E.

FIG. 4E shows a GUI accessed by selecting the “Execution Plan” tab. The GUI can display the track name and steps associated with that track. A user may create new tracks and corresponding steps for the tracks from this GUI. A step can be a configured action to send a communication to a campaign participant, and tracks can be used to organize and contain the steps in the marketing campaign. In the example shown in FIG. 4E, the user can select the hyperlink labeled “Create New” next to the text “Tracks” to create a new track. Similarly, a user can create a new step for the generated track by selecting the hyperlink labeled “Create New” next to the text “Steps.” The GUI also can display track routes that may route a campaign participant from one track to another, a different track. The steps and track routes will be described in more detail below. Additionally, in certain implementations, marketing leads can be routed directly outside of the campaign to a customer resource management (CRM) system, an external destination, or a person based on user defined rules and conditional statements.

The GUI in FIG. 4E may display an “Edit Track” window when the track is selected for editing or upon creation of a new track. The user can modify the name of the track and other metadata associated with the track, such as a track description.

After the track is added 304, a step can be added to the marketing track 306, as indicated by FIG. 3. For example, the user can add a first step 220 to the first track 218, as shown in FIG. 2. The user can add steps to tracks using a GUI, such as the GUI shown in FIG. 4F. For example, the user can select the hyperlink “Create New” next to the text “Steps,” as described above. Selecting this hyperlink can launch the window 410, where the user can enter settings and metadata associated with the step. The user can enter a name for the step, a description, an action the step indicates (e.g., send email, send direct mailing, call telephone number), and an execution date for the step.

The user can also specify that behavioral information associated with individual campaign participants satisfy predefined criteria or rules before the marketing application initiates the action indicated by the step. For example, a user may select a GUI component, such as the hyperlink “these rules” shown in the window 410 of FIG. 4F. The selection can launch an “Edit Rules” window 412 where the user can create rules. Additionally, the user can launch additional windows, such as the window 414, which permits a user to select categories of resources, a particular resource within a category, and natural language statements associated with the particular resource.

In the example shown in the window 414 of FIG. 4F, the user can select a “they did not view this microsite” statement. Using this statement, the user can condition the transmission of the email specified in the corresponding step upon a campaign participant's behavior, namely, that the participant did not view the microsite specified in window 414.

The user can also specify that one or more time conditions be satisfied before the marketing application initiates an action indicated by a step. For example, the user can specify that a campaign participant must open an email message within one week of receiving the email. Unless the campaign participant opens the email message before this time, the participant will not receive the communication indicated by the current step. The user can enter the time conditions, including time intervals, in a GUI, such as the GUI shown in FIG. 4G.

After a step has been added, a user may add additional steps to the track 308, as indicated by the method 300 of FIG. 3. For example, the user can create a second step 222. The user may create the second step 222 by repeating the operation 306 of the method 300 and by using similar GUIs as described in association with the creation of the first step 220.

After the user has added as many steps as desired to the first track 218, additional tracks can be added 310, as indicated by FIG. 3. For example, the user can generate a second track 224 as shown in FIG. 2. The user may generate the second track 224 by repeating the operation 304 of the method 300 and by using the same GUIs as described in association with the generation of the first track. After the user creates the second track 224, additional steps, such as a third step 226, can be added to the second track as described above.

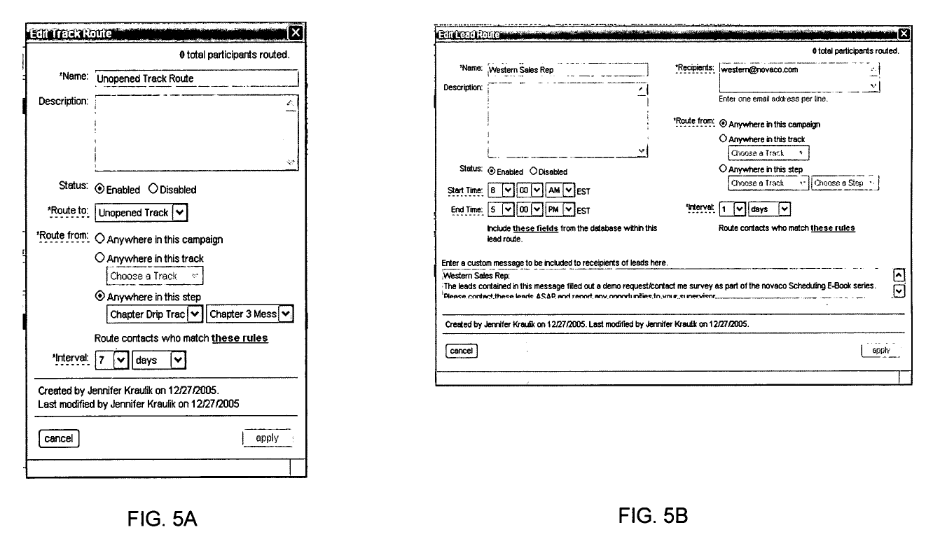

When the user has added as many tracks as desired, routing rules, such as a routing rule 228, can be added 312, as indicated in the method 300 of FIG. 3. Referring to FIG. 2, the routing rule 228 can include a routing condition 230 and a time condition 232 that can specify a description of a behavior and a time that the behavior should occur, respectively. For example, the user can enter the routing rule 228 in a GUI, such as the GUI shown in FIG. 5A. The user may enter the name of a track route which applies the routing rule 228, a description of the track route, where the campaign participants should be routed (e.g., which track or step), and from which track and which step the participants should be routed.

Additionally, the user can specify the routing condition 230. The track route can route a campaign participant to a different track if the routing condition is satisfied. For example, the user can specify the routing condition 230 by selecting a hyperlink “these rules” shown in FIG. 5A. The selection can launch a window similar to the window 412 of FIG. 4F. The user can then generate the routing condition 230 or conditions by creating the rules and statements using a similar method as described for the rules and statements associated with the first and second steps 220, 222.

Similarly, the user may specify the time condition 232 to be satisfied before the marketing application routes a campaign participant to a different track. The user can create the time condition using as similar method as described in association with the FIG. 4G.

The marketing application 102 can also automatically collect and transfer leads (e.g., campaign participants) from any step or track in the marketing campaign. The user can generate a lead route 314 as indicated in the method 300. The lead route can route information 234 associated with campaign participants to one or more lead recipients 236, as shown by arrow 238 in FIG. 2.

The user can create the lead route by entering information into a GUI, such as the GUI shown in FIG. 5B. For example, the user can enter the name of the lead route, a description of the lead route, contact information for the lead recipient (e.g., email address, telephone number, file transport protocol (FTP) locations, CRM system, or mailing address), a step or track from which to route, time intervals at which to forward the leads (e.g., every seven days), and a time when the marketing application should forward the leads (e.g., between 8 a.m. and 5 p.m. EST).

The user can specify routing criteria used to filter out campaign participants when routing. The user may enter the criteria in a manner similar to the method used to enter the rules and statements associated with the steps as described above. Additionally, the user can specify messages to accompany the information associated with the campaign participants that qualify as leads.

### Execution of a Marketing Campaign

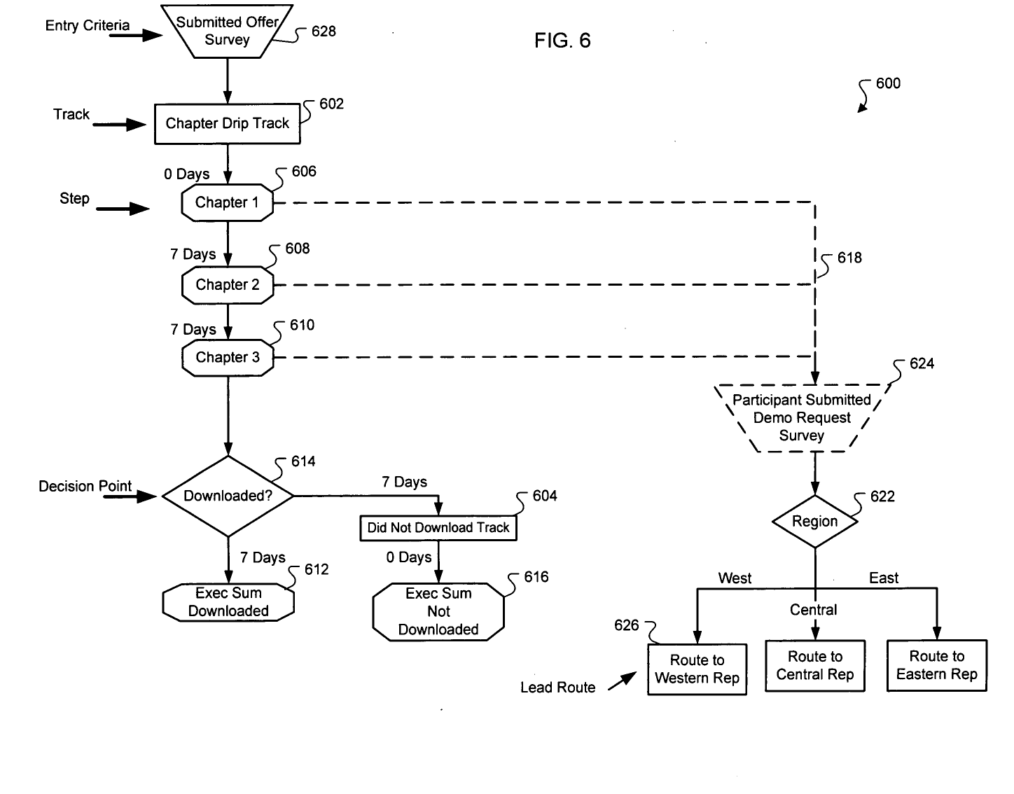

FIG. 6 is an example 600 of a behavior-based marketing campaign with multiple tracks. The marketing campaign of the example 600 includes two tracks. The first track is titled “Chapter Drip Track” 602, and the second track is titled “Did Not Download Track” 604. In this example, the marketing campaign may transmit different chapters of an E-book to campaign participants. The Chapter Drip Track 602 includes four steps: Chapter 1 606, Chapter 2 608, Chapter 3 610, and Exec Sum Downloaded 612. Each of the Chapter steps may specify which chapters of the E-book the marketing application should transmit (e.g., email) to the campaign participants. The step Exec Sum Downloaded 612 can specify the summary that the marketing application should transmit to campaign participants if the participants have downloaded each chapter previously emailed.

The Chapter Drip Track 602 also includes a track route 614, which determines whether the campaign participants have downloaded the previous chapters. If the routing rule not satisfied (e.g., a campaign participant downloads Chapters 1-3 within a specified time), the campaign participant can continue on the first track and execute the step Exec Sum Downloaded 612, which is a truncated summary of the three chapters. If the routing rule is satisfied (e.g., the campaign participant does not download one of the three chapters), the campaign participant is routed to the Did Not Download Track 604.

Once the participant is associated with the Did Not Download Track 604, the application can send the participant a summary specified by a step Exec Sum Did Not Download 616. In this example, the summary specified by step 616 includes a comprehensive summary written with the assumption that the participant did not read Chapters 1-3.

At any of the steps 606-610, the marketing application can route a campaign participant to a lead recipient as indicated by arrow 618. In the example 600, the marketing application routes the campaign participant to a track route, which routes information associated with the campaign participant to a lead route based on a region in which the participant is located.

Routing criteria 624 filters campaign participants so that only the participants that submit a “Demo Request Survey” in response to the one of the steps 606-610 are routed to the lead route 622. If the campaign participant is located in a predefined western area, the marketing application can route information associated with the campaign participant to the western representative. Similarly, the marketing application can route the information to a central or eastern representative if the campaign participant is located in those regions.

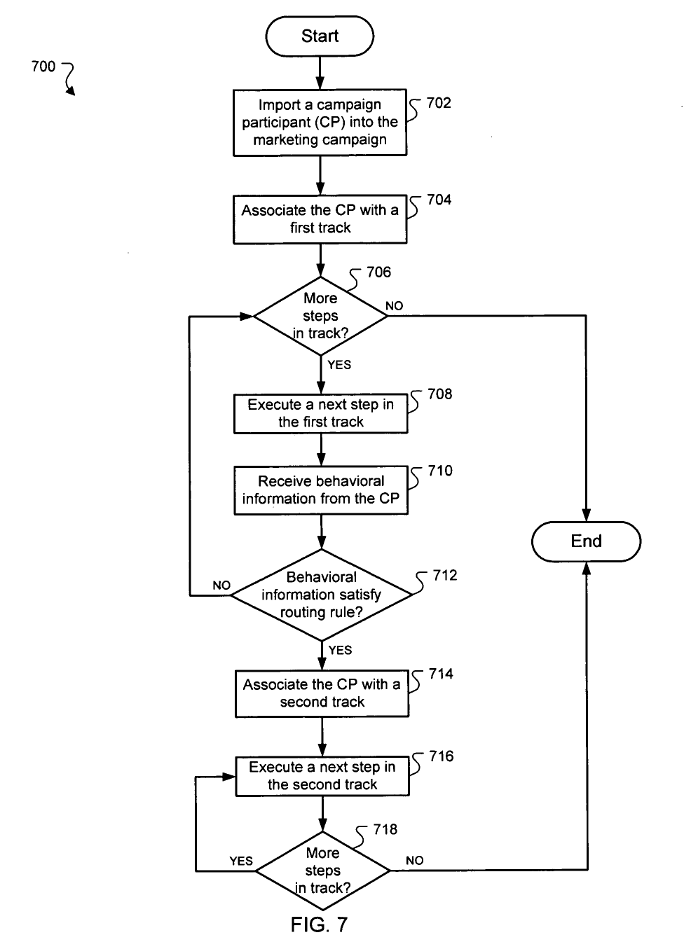

FIG. 7 is a flowchart of an illustrative method 700 for routing campaign participants based on their behavioral information. For example, the method 700 can be used to route participants through the marketing campaign shown in FIG. 6.

The method can start by importing campaign participants into a marketing campaign 702. For example, the marketing application 106 can import contacts from a selected database 126 if the contacts meet campaign entry criteria, such as the criteria that the contacts submitted an offer survey 628. The imported contacts, or campaign participants, can be associated with a first track 704, such as the Chapter Drip Track 602.

The marketing application can determine if there are steps in the track that the application has not initiated 706. If there are steps in the track, the application can initiate the communication specified by the step 708. For example, the application 106 can transmit Chapter 1 of the E-Book using an email, which is specified by the step Chapter 1 606.

The marketing application can receive behavioral information associated with the campaign participant 710. For example, a campaign participant can download Chapter 1 within one week of receiving the communication specified by the step Chapter 1 602. A web server hosting Chapter 1 can log the download and transmit this log to the marketing application.

The application then can determine whether the behavioral information satisfies a routing rule 712. If the behavior information indicates that the campaign participant has not satisfied the routing condition, the method can execute steps 706-712 again. For example, if the marketing application receives behavioral information 116 that indicates that the participant downloaded all three chapters specified in the steps 606-610, the marketing application can keep the campaign participant in the Chapter Drip Track 602 and execute the step Exec Sum Downloaded 612.

If the behavioral information, however, indicates that the participant has satisfied the routing rule, the application can associate the participant with a second track 714. For example, if the participant did not download all three chapters of the E-book, the marketing application may route the participant to the Did Not Download Track 604. The application then can execute the steps in the second track 716 as long as the system determines that there are more steps 718. When there are no more steps in either the first or the second track, the method 700 can end.

Although not shown in FIG. 7, the method 700 can also include additional steps, such as routing to a third or fourth track based on behavioral information. Additionally, the application can use the behavioral information to route the campaign participant information to lead recipients as discussed in association with FIG. 6.

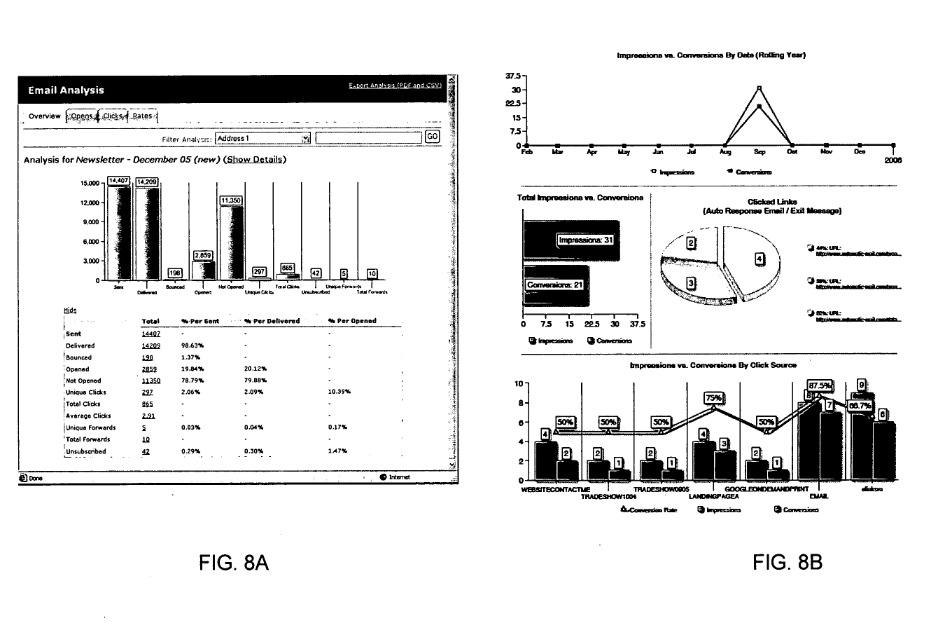

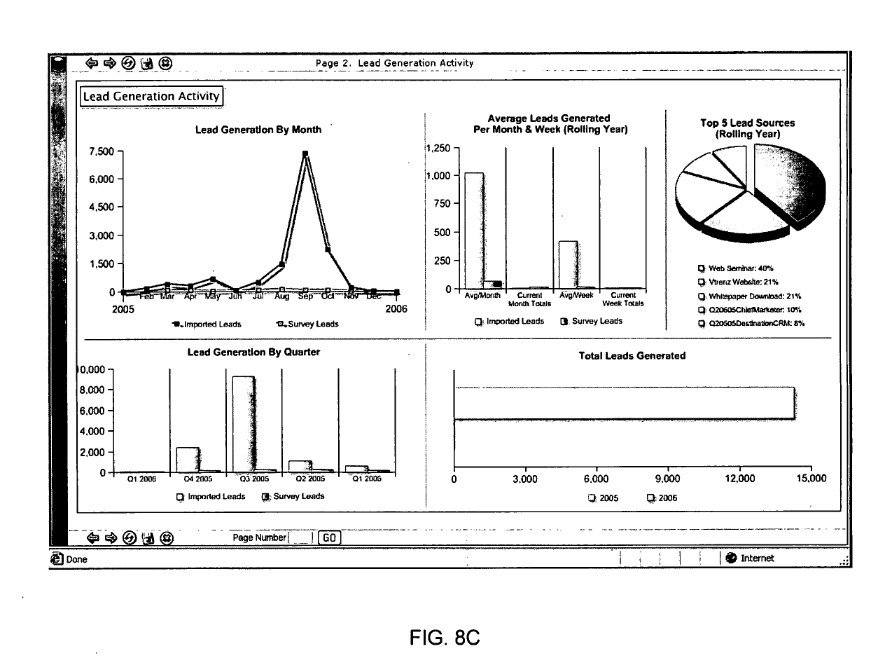

FIGS. 8A-8C are examples of GUIs generated by the system 100 during analysis of the behavior-based marketing campaign. FIG. 8A is screenshot of a GUI that can display click-level tracking, details by campaign participant, and multilevel analysis. FIG. 8B is a screenshot of a GUI that can display database analysis along with a survey response analysis. Additionally, the GUI can display responses by marketing tactic (e.g., paid words, web-site location, and click-sources). FIG. 8C is a screenshot of a GUI that can track and display the overall campaign history and can make month-to-date, quarter-to-date, and year-to-date comparisons. Additionally, the GUI can display information, such as overall lead generations and impressions.

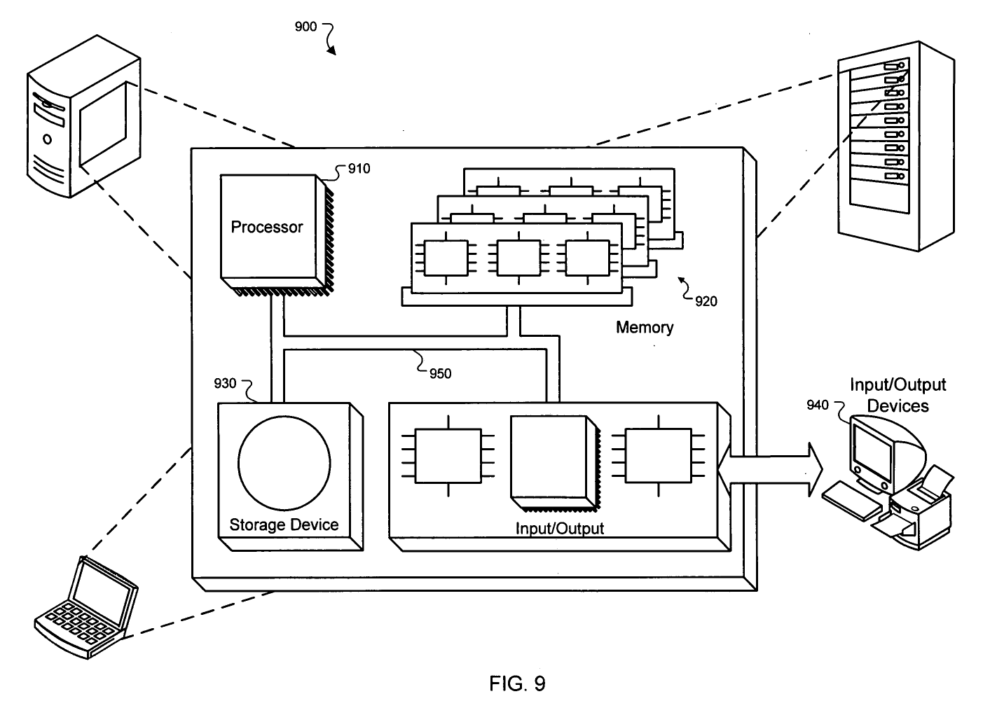

FIG. 9 is a schematic diagram of a general computing system. The system 900 includes a processor 910, a memory 920, a storage device 930, and an input/output device 940. Each of the components 910, 920, 930, and 940 are interconnected using a system bus 950. The system 900 may be included as all or part of the first, second, and third computing devices 104, 110, 120 as shown in FIG. 1. The processor 910 is capable of processing instructions for execution within the system 900. For example, the processor 910 can be a microcontroller that executes instructions that carry out the methods 300 and 700. In some implementations, the processor 910 is a single-threaded processor. In other implementations, the processor 910 is a multi-threaded processor. The processor 910 is capable of processing instructions stored in the memory 920 or on the storage device 930. In some implementations, the processed instructions may generate graphical information for a user interface, such as the GUIs shown in FIGS. 4A-4G and FIGS. 8A-8C, on the input/output device 940.

The memory 920, which is a computer-readable medium, stores information within the system 900. In some implementations, the memory 920 is a volatile memory unit. In other implementations, the memory 920 is a non-volatile memory unit. The memory may be suitable for tangibly embodying computer program instructions and data. The instructions and data can be loaded into memory from an external source, such as the storage device 930 or the input/output device 940.

The storage device 930 is capable of providing mass storage for the system 900. In some implementations, the storage device 930 is a computer-readable medium. In various different implementations, the storage device 930 may be a floppy disk device, a hard disk device, an optical disk device, or a tape device.

The input/output device 940 provides input/output operations for the system 900. In some implementations, the input/output device 940 includes a keyboard and/or pointing device. In other implementations, the input/output device 940 includes a display unit for displaying graphical user interfaces, such as the GUIs in FIGS. 4A-G and 8A-C.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The components of the system can be connected by any form or medium of digital data communication such as a communication network. Examples of communication networks include, e.g., a LAN, a WAN, and the computers and networks forming the Internet.

A number of embodiments have been described. Nevertheless, it will be understood that various modifications may be made without departing from the spirit and scope of the described embodiments. For example, the creation of track routes 312 in the method 300 can be made before the user has created all the tracks. Also, all of the steps for one track need not be created before a new track is created.

Additionally, when the marketing application generates a campaign, it may include one or more default tracks that may contain one or more default steps. For example, an “end track” may be a hidden track that is automatically a component of each campaign. The user can configure the application to route campaign participants to the end track from track routes. When participants are associated with the end track, they “finish” the campaign. The user can modify the campaign settings to allow the participants to repeat the campaign when the participants are marked as finished. Additionally, tracking which participants finish the campaign and when may facilitate statistical analysis of certain aspects of the campaign, such as the average campaign completion time. Accordingly, other embodiments are within the scope of the following claims.

What is claimed is:

1. A computer-implemented method for managing participants of a marketing campaign, the method comprising:
generating a marketing campaign with multiple tracks, wherein each track comprises one or more steps that indicate an activity executed on campaign participants;
generating segmentation conditions based on natural language statements, each segmentation condition comprising a rule and a time condition; and
associating a campaign participant from a first track to a second track if behavior information satisfies a segmentation condition, the behavior information comprising a response by the campaign participant to an activity indicated by a step in the first track.

2. The method of claim 1, further comprising using profile information for the campaign participant to determine whether to associate the campaign participant from the first track to the second track.

3. The method of claim 2, wherein the profile information is selected from a group consisting of contact information, firmagraphic information, demographic information, marketing data collected by third parties, and previous campaign activity data associated with the campaign participant.

4. The method of claim 2, wherein the profile information is updated based on an occurrence comprising the campaign participant purchasing a product, a change in company information associated with the campaign participant, or a change in a lifecycle status of the campaign participant.

5. The method of claim 1, further comprising routing information associated with the campaign participant to an external destination if the behavior information or a profile associated with the campaign participant satisfies a rule of a second segmentation condition.

6. The method of claim 5, wherein the external destination comprises a customer resource management system, an electronic device, or a human contact manager.

7. The method of claim 1, wherein the activity executed on the campaign participants is selected from a group consisting of removing or adding a campaign participant from the marketing campaign, transmitting a communication to a campaign participant, routing a campaign participant from one track to a different track, initiating an external process, and updating profile information associated with a campaign participant.

8. The method of claim 1, wherein the activity executed on the campaign participants comprises a communication of a digital document with variable contents transmitted through a network to the campaign participant.

9. The method of claim 1, wherein the natural language statements include conditions based on information selected from a group consisting of website activity by campaign participants, profile information for campaign participants, response behavior by campaign participants, and external marketing data to be used in campaign execution activities.

10. The method of claim 1, wherein the behavior information or a profile associated with the campaign participant indicates that the campaign participant initiated a response to an electronic communication including email, a landing page, a web page, a Really Simple Syndication (RSS) feed, message received by a mobile device, an instant message, or telephone call.

11. The method of claim 1, wherein the behavior information or a profile associated with the campaign participant indicates that the campaign participant responded to an online advertisement, a direct-response advertisement, a direct mailing, or participated in a telephone solicitation.

12. The method of claim 1, further comprising comparing campaign entry criteria to a profile or behavior information associated with a contact to determine whether the contact should become a participant of the marketing campaign.

13. The method of claim 12, further comprising receiving input from a user defining the campaign entry criteria.

14. The method of claim 12, wherein the entry criteria comprises natural language statements of conditions to be satisfied.

15. The method of claim 12, wherein the comparison is executed at date-based or fixed intervals after the marketing campaign begins.

16. The method of claim 1, wherein the segmentation condition further comprises a description of a profile or behavior information for the campaign participants and a track or step to associate the campaign participants with if received profile or received behavior information for the campaign participants corresponds to the description.

17. The method of claim 1, wherein the time condition comprises a period in which the response by the campaign participant to an activity should take place, wherein the time condition is relative to a previous step, a current step, a current track date, a campaign, or is relative to a fixed date.

18. The method of claim 1, further comprising comparing an exit condition to a profile associated with the campaign participant or the behavior information to determine whether the campaign participant should exit the marketing campaign by being associated with an ending track of the marketing campaign.

19. The method of claim 1, further comprising manually inputting the response by the campaign participant to the activity into a database.

20. The method of claim 1, further comprising securely transmitting profile or the behavior information associated with the campaign participant to a lead recipient if the profile or behavior information associated with the campaign participant satisfies a lead route condition predefined by a user.

21. The method of claim 20, wherein the lead route condition comprises at least one natural language statement of a condition to be satisfied.

22. The method of claim 20, wherein the information associated with the campaign participant is transmitted to the lead recipient using an electronic device comprising a facsimile machine, an email device, a cellular telephone, an RSS feed, a web page, or a mobile device.

23. The method of claim 20, wherein the lead route condition is compared with the profile or behavior information associated with the campaign participant after the marketing campaign begins.

24. The method of claim 20, wherein the lead route condition is compared with the profile or behavior information associated with the campaign participant at predefined time intervals.

25. The method of claim 1, wherein each step comprises a step rule having a rule condition to be satisfied before an associated activity is performed.

26. The method of claim 25, wherein the step rule comprises at least one natural language statement of the rule condition to be satisfied.

27. The method of claim 26, further comprising receiving from a user input that defines the at least one natural language statement of the rule condition.

28. The method of claim 1, further comprising statistically analyzing the behavior information.

29. A system comprising:
a campaign tool for generating a marketing campaign comprising multiple tracks, wherein each track comprises a predefined series of one or more steps, which indicate an activity to be executed on a campaign participant of the marketing campaign;
a design manager for generating a marketing asset used in dynamic communications transmitted to a campaign participant; and
a list manager to generate one or more rules, wherein the rules specify one or more natural language conditions to be satisfied before an activity is executed to the campaign participant.

30. A computer program product tangibly embodied in an information carrier, the computer program product including instructions that, when executed, perform operations comprising:
generating a marketing campaign with multiple tracks, wherein each track comprises a series of one or more steps that indicate an activity to be executed on a campaign participant;
associating a campaign participant with a first track;
receiving behavior information based on a response by the campaign participant to the activity indicated by a step in the first track; and
associating the campaign participant with a second track if the behavior information satisfies a routing rule comprising a routing condition and a time condition.
